(19) United States
(12) Patent Application Publication
(10) Pub. No.: US 2014/0017440 A1
(43) Pub. Date: Jan. 16, 2014

(54) STRUCTURE OF GRAPHENE OXIDE, THE METHOD OF FABRICATION OF THE STRUCTURE, THE METHOD OF FABRICATING FIELD-EFFECT TRANSISTOR USING THE STRUCTURE

(71) Applicant: National Institute of Advanced Industrial Science and Technology, Tokyo (JP)

(72) Inventor: Yoshiyuki Miyamoto, Tsukuba-shi (JP)

(73) Assignee: National Institute of Advanced Industrial Science and Technology, Tokyo (JP)

(21) Appl. No.: 13/938,724

(22) Filed: Jul. 10, 2013

Related U.S. Application Data
(60) Provisional application No. 61/669,976, filed on Jul. 10, 2012.

(51) Int. Cl. B01J 19/12

(52) U.S. Cl. CPC B01J 19/121
USPC 428/98; 204/157.41

(57) ABSTRACT

A sheet material has structures of graphene oxide and graphene in which the graphene oxide and the graphene are chemically connected and coexist to form a plane such that the plane is divided into a region of the graphene oxide and a region of the graphene. A method of reduction of graphene oxide includes providing a sheet material having at least one atomic layer of graphene oxide and a femtosecond laser apparatus that can emit a femtosecond laser shot in a controlled manner. A pulse shape and intensity of an electric field formed by the laser shot are tuned so that the laser shot can be emitted onto a region of the graphene oxide sheet in a controlled manner to selectively cause reduction of the graphene oxide of the region.

### CROSS-REFERENCE OF RELATED APPLICATIONS

This application claims priority to Provisional Application No. 61/669,976, filed Jul. 10, 2012, the entire contents of which are incorporated herein by reference.

### TECHNICAL FIELD

This invention relates to a structure of graphene oxide, a fabrication method of the structure, and a fabrication method of a field-effect transistor using the method and the structure.

### BACKGROUND ART

Graphene attract high interest as a novel low-dimensional material.

Due to its high carrier mobility, flexible mechanical property, realization of transparence and conductance, no one can tell the limit for the possible applications of graphene as an electric material.

Because of high carrier mobility, field effect transistor made of graphene is expected as next generation transistor alternative to conventional CMOS made of silicon.

However, due to narrow band-gap of graphene, the graphene transistor has small on/off ratio that may cause high energy consumption during its operation.

To solve this problem, channel made of finite width of graphene sheets (graphene ribbons) is proposed, however the required width of the graphene ribbon must be in the order of nm to get band-gap which makes the fabrication of graphene nano-ribbon extremely hard.

Under such difficulty, chemical procedure for fabricating graphene took a lot of attention.

Using chemical species as surfactant combined with solvent, fabrication of graphene ribbon possessing the band-gap by performing the ultrasonication of graphene in the solvent was reported (non-patent reference 3).

However, remnant surfactant should degrade performance of graphene transistor, which means the reduction of carrier mobility.

Instead of using surfactant, intentional oxidation of graphene and subsequent peeling off the graphene oxide layers were reported. (Non-patent reference 4, and patent reference 1).

The structure of graphene oxide is made of epoxy structure (as shown in lower panel of FIG. 1, one oxygen atom bonds to two neighboring carbon atom), or of hydroxyl structure (one OH group makes a single bond with a carbon atom). The layer-by-layer exfoliation of graphene oxide sheets is easily achieved in water from graphite.

However, as oxidized, the resistance is so high for the application as electric material, so we must reduce the graphene oxide. (After reduction, we obtained the structure shown in upper panel of FIG. 1.)

Use of hydrazine (H₂H₂) is one of the popular methods of the reduction (non-patent reference 5, patent reference 2), but microscopic analysis (non-patent reference 6) revealed problems coming from new formation of hydroxyl contaminants which comes after decomposition of hydrazine molecules as well as necessity of high temperature during reduction process.

Moreover, by using chemical method of reduction it is very hard to perform spatially selected reduction.

However, if we can perform spatially selected reduction of graphene oxide, fabrication of graphene oxide region and pristine graphene region can be realized in controlled manner on single graphene sheet that makes conducting region and insulating region on one sheet and makes fabrication of the transistor very promising.

### PATENT REFERENCE

[Patent reference 1] JP 2010-275186
[Patent reference 2] JP 2010-248066
[Patent reference 3] JP 2011-33476

### Non-Patent Reference

[Non-patent reference 1] A. Renia, X. Jia, J. Ho, D. Nezich, H. Son, V. Bulovic, M. S. Dresselhaus, and J. Kong, Nano Lett. Vol. 9, p30, 2009
[Non-patent reference 2] Y. Lee, S. Bae, H. Jang, S. Jang, S.-E. Zhu, S. H. Sim, Y. I. Song, B. H. Hong, and J.-H. Ahn, Nano Lett. Vol. 10, p490, 2010
[Non-patent reference 3] X. Li, X. Wang, L. Zhang, S. Lee, H. Dai, Science Vol. 3 19, p1229, 2008
[Non-patent reference 4] D. Li, M. B. Muller, S. Gilje, R. B. Kaner, and G. G. Wallace, Nature Nanotechnol, Vol. 3, p101, 2008
[Non-patent reference 5] V. C. Tung, M. J. Allen, Y. Yang, and R. B. Kaner, Nature Nanotech. Vol. 4, p25, 2009
[Non-patent reference 6] M. C. Kim, G. S. Hwang, and R. S. Ruoff, J. Chem. Phys. Vol. 131, p064704, 2009
[Non-patent reference 7] Y. Miyamoto and H. Zhang, Phys. Rev. B Vol. 77, p165123, 2008
[Non-patent reference 8] Y. Miyamoto, O. Sugino, and Y. Mochizuki, Appl. Phys. Lett., Vol. 75, p2915, 1999
[Non-patent reference 9] Ch. Spielmann, N. H. Burnett, S. Sartania, R. Koppitsch, M. Schnurer, C. Kan, M. Lenzner, P. Wobrauschek and F. Krausz, Science Vol. 278, p661, 1997

### SUMMARY OF THE INVENTION

As already mentioned, a chemical reaction can form a structure of graphene oxide shown in FIG. 2, in which all region of a graphene sheet is adsorbed with oxygen.

Chemical processes of reduction of graphene oxide realize uniform/or random reduction that unable to control the reduction region, so the limited reduction like hatched area as shown in FIG. 2 was impossible.

In order to perform controlled segregation of the oxide region and pristine region on a single graphene sheet, the reduction of graphene oxide in a controlled manner is highly required.

This invention has found a structure of graphene oxide obtained after the reduction, and an application of such structure for a graphene device.

This invention is characterized by the structure in which the graphene oxide region and pristine graphene region can coexist in spatially segregated area on a single graphene sheet.

To realize the structure mentioned above, this invention provides following methods.

In one aspect, the invention is a method of reduction of graphene oxide. The invention includes at least following steps: the step for preparation of sheet materials of atomic layer of graphene oxide and instrument of femtosecond laser that can emit the laser shot onto the sheet, the step for tuning a pulse shape and intensity of optical electric field of the laser shot, the step for emitting the laser shot onto a controlled position of the graphene oxide sheet using the tuned pulse shape and intensity of the electric field as mentioned above. This invention thus provides a reduction method of graphene oxide being characterized with steps mentioned above.

The step tuning a pulse shape and field intensity has characteristics such that the full-width of half-maximum of the pulse is 2 fs, the wavelength of the laser is 800 nm, and the averaged intensity of the laser field for time-range of 4 fs of laser duration is kept as negative direction with respect to the normal axis to graphene sheet. Being characterized with above steps, this invention provides methods of graphene reduction.

Here, the field of femtosecond laser changes its intensity and polarity depending on time, so averaged field means the time-average.

And the polarity of the field of the femtosecond laser directing upward along with sheet normal direction of graphene is called as “positive”, and the polarity directing downward is called as “negative”.

Practically, the step determining negative polarity of the time-averaged electric field with respect to the normal to the graphene sheet is decomposed by following steps: (S301) The first positive threshold is in positive direction, and the second threshold that has five times intensity of the first threshold is in negative direction, (S302) changing the zero field into the strength and polarity of the first threshold, mentioned above, in the time range from 0 fs to 1 fs, that is a quarter of the full width of half maximum of the pulse, (S303) changing the intensity and polarity of the first threshold mentioned above to those of the second threshold mentioned above in the time range from 1 fs to 2 fs, that is a quarter of the full width of half maximum of the pulse, (S304) changing the intensity and polarity of the second threshold to those of the first threshold in the time range from 2 fs to 3 fs, that is a quarter of the full width of half maximum of the pulse, and (S305) changing the intensity and polarity of the first threshold to zero field in the time range from 3 fs to 4 fs, that is a quarter of the full width of half maximum of the pulse.

In the pulse shape of the femtosecond laser, mentioned before, this invention consists on following steps: The step tuning maximum intensity of the field from 10V/Å to 20 V/Å, the step keeping environment of graphene oxide under nitrogen gas or under hydrogen gas when laser shot is applied on the sheet. This invention is characterized with above steps.

This invention is a method to remove solely of oxygen atom selectively from graphene surface by irradiating with femtosecond laser, and pulse shape and intensity of electric field of the laser is the characteristic feature of this invention.

This invention can also predict conditions in the pulse shape and electric field intensity of the femtosecond laser by performing time-dependent first-principles simulation prior to experiment in order to achieve high efficiency in extracting oxygen atoms from graphene when practical experiment is performed.

Thanks to this prediction for conditions of the femtosecond laser, we can perform spatially selected reduction of the graphene oxide by segregating laser illuminated region and non-illuminated region on a single graphene sheet as displayed in FIG. 2.

In the hatched area of FIG. 3, reduction is made and as illustrated as inset, the honeycomb pattern of carbon network is realized.

Meantime, in non-hatched region, the structure of graphene oxide is realized and epoxy structure by adsorbed oxygen atom is realized as illustrated in the inset of FIG. 2.

Therein, this invention provides a peculiar sheet possessing structures of graphene oxide and graphene, and these structures are chemically connected as a single sheet of graphene, and this graphene sheet is spatially divided into the graphene oxide region as mentioned above and graphene region as mentioned above.

And this invention provides a patterning method using the reduction method, as mentioned above, controlling the region of irradiation with femtosecond laser on graphene oxide. This method provides pattern of coexistence of graphene oxide and graphene on a single sheet of graphene.

As an example of controlled region of graphene reduction, FIG. 7 shows oval pattern as conducting region.

### EFFECTS BY THE INVENTION

This invention can provide flexible designing of reduced region since the irradiation with femtosecond extract oxygen atoms only from graphene oxide.

Furthermore, by tuning pulse shape and intensity of the laser show, the amount of remaining oxygen on the irradiated region is controllable to design conducting property of the region.

### BRIEF DESCRIPTION OF DRAWINGS

FIG. 1 schematically shows chemical bonding by individual atoms that make graphene oxide (lower) and graphene (upper).

FIG. 2 shows a structure made of graphene oxide and graphene.

FIG. 3(a) shows flow chart of detailed steps that tunes the average intensity of the electric field of the laser in negative direction along with respect to the normal axis to the graphene plane.

FIG. 3(b) shows flow chart of detailed steps that tunes the average intensity of the electric field of the laser in positive direction along with the normal to the graphene plane.

FIG. 4(a) shows four types of pulse shape of the femtosecond laser with time-interval of 4 fs, while FIG. 4(b) shows time-evolution of kinetic energy given on an oxygen atom by the laser shots with four types of the pulse shape, as displayed in FIG. 4(a).

FIG. 5 shows relation between the kinetic energy on an oxygen atom given by the femtosecond laser and the maximum intensity of the electric field of the laser.

FIG. 6 schematically shows reduction process of graphene oxide realized by desorption of oxygen atoms from graphene surface upon irradiation with the femtosecond laser.

FIG. 7 shows an oval pattern of current conducting region made at the center of graphene oxide sheet.

FIG. 8 shows graphane (H-terminated graphene on both sides).

FIG. 9 shows upper side dehydrogenated graphane of FIG. 8, who remains hydrogen atoms in lower side.

FIG. 10 shows graphene structure one side of which is terminated by chlorine atoms and the other side of which is terminated by hydrogen atoms.

FIG. 11 shows two sheet of graphene structure who has chlorine atoms on one side and hydrogen atoms on the other side. The orientation of the two sheets is set as the chlorine terminated plane face-to-face and the electric bias of this structure was evaluated by the first-principles calculation.

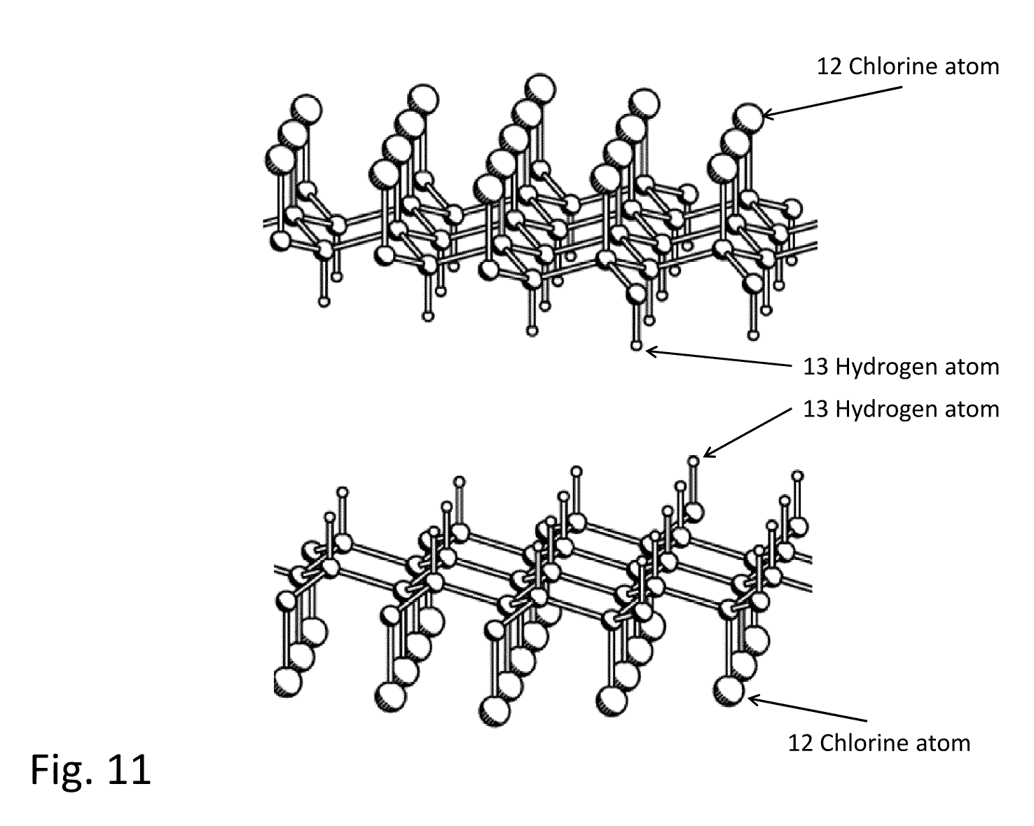

FIG. 12 shows two sheet of graphene structure who has chlorine atoms on one side and hydrogen atoms on the other side. The orientation of the two sheets is set as the chlorine terminated plane and the hydrogen-terminated plane face-to-face and the electric bias of this structure was evaluated by the first-principles calculation.

### EMBODIMENTS OF THE INVENTION

### Example 1

By applying a method explained above, graphene region can be formed at a controlled region of single sheet of graphene oxide.

In realistic situations, femtosecond laser with the controlled pulse shape and positive or negative intensity in time-averaged electric field tuned by an established method is shined from either front or back side of graphene sheet to reduce the targeted region of graphene oxide.

Or by using the femtosecond laser shot having positively tuned time-averaged electric field at once and the laser shot having negatively tune time-average electric field at one, the irradiated region of graphene oxide is reduced no matter how oxygen atoms are aligned on front/back side of graphene.

Thereof the single sheet of graphene can be provided with controlled region of graphene oxide and region of pristine graphene.

### Example 2

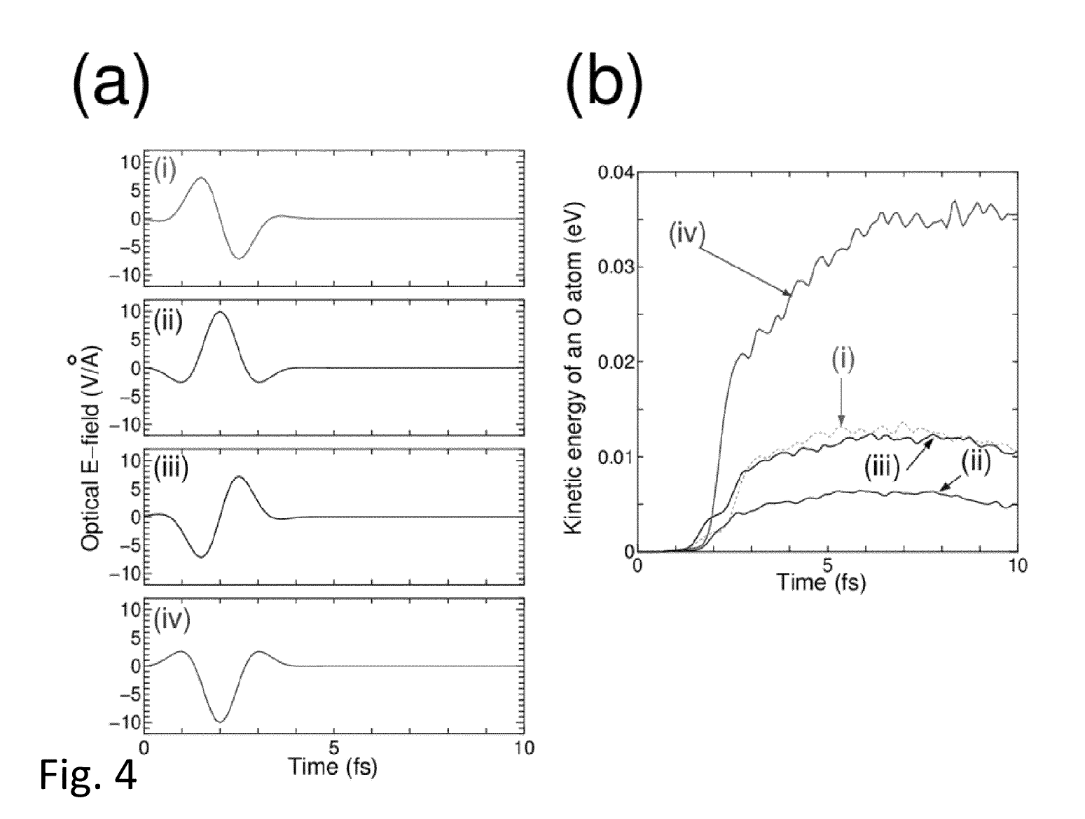

The pulse shape of the femtosecond laser used in this invention can tube its phase by modifying setup of optical instruments as displayed in FIG. 4(a) (i to iv).

In call cases, the pulse width is set as 2 fs, the wavelength is set as 800 nm, and particularly in this invention, the polarization vector of the laser is perpendicular to graphene sheet.

Without special instruction in this document, the femtosecond laser is shined from upper region toward down region in all displayed figures.

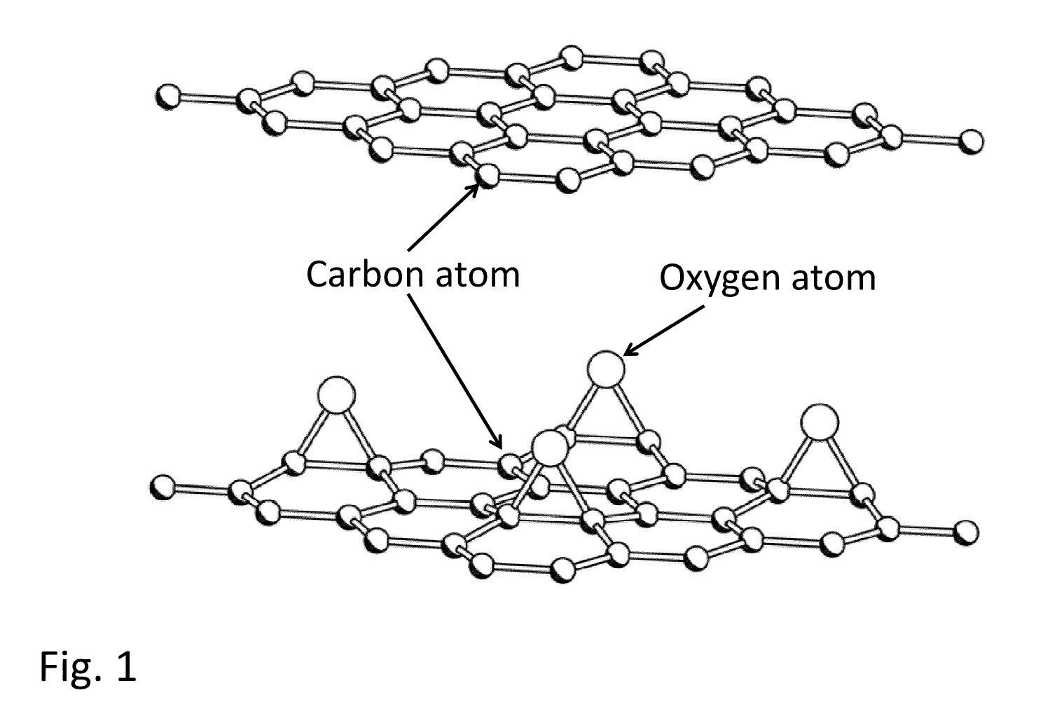

And, without special instruction in this document, the direction of chemical bond of oxygen atom is on the upper region of graphene surface as displayed in FIG. 1.

FIG. 4(a) (i to iv) show variety of phases that determine the pulse shapes of the laser with maximum instantaneous electric field as 10 V/Å.

The reduction method is as following procedure: First a sheet of graphene oxide and instruments of the femtosecond laser is prepared, next the pulse shape and intensity of the laser are tuned, and laser pulse is shot on controlled region of the graphene oxide, thus reduction of graphene oxide as demanded region is completed.

In practical situation, reduction of graphene oxide as displayed in FIG. 1 is completed by shining a laser with full width of half maximum of 4 fs and with the time-averaged electric field to negative direction of the graphene sheet.

Meanwhile, when the bonding direction of oxygen atom is as opposite to that in FIG. 1, the reduction is completed with the same laser shot but opposite polarity of the time-averaged electric field.

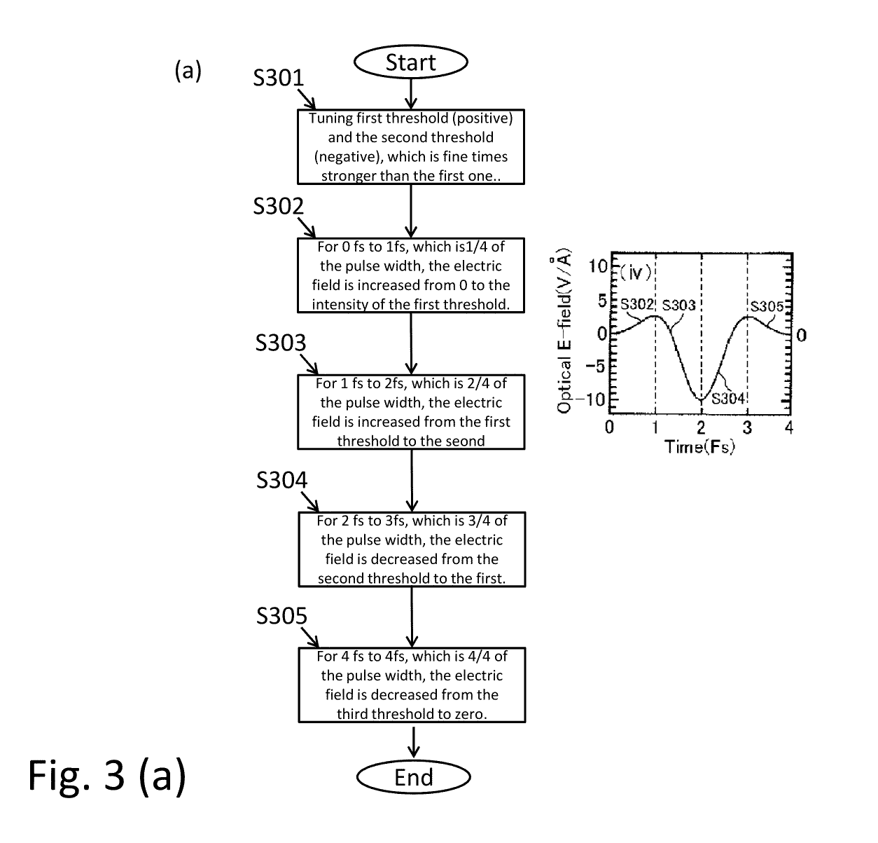

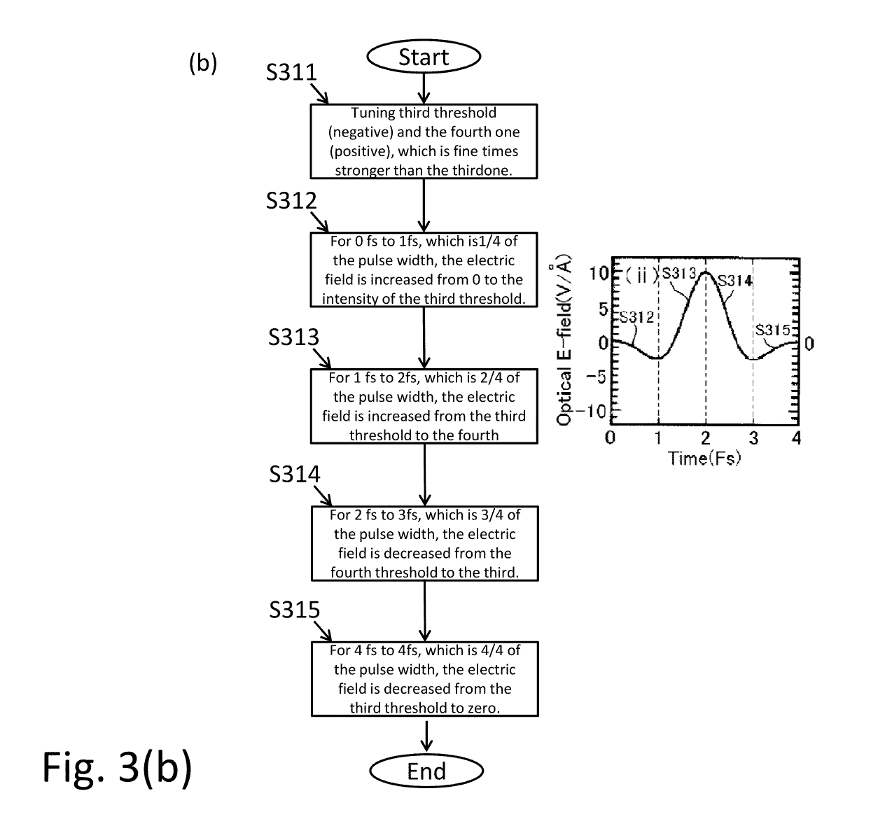

For more concrete explanations, the detailed flow-chart is displayed in FIG. 3(a) that shows steps to tune the time-averaged electric field as negative direction to the normal to the graphene sheet, while the chart is displayed in FIG. 3(b) that steps to tune the time-averaged electric field as positive direction to the normal to the graphene sheet.

On the right hand side of flow-chard displayed in FIGS. 3(a) and (b), the schematics of pulse shapes continuously generated by sub-steps is displayed in FIG. 4 (a) (iv) for the pulse in FIG. 3(a), and in FIG. 4 (a) (ii) for the pulse in FIG. 3(b).

In FIG. 3(a), the detailed flow-chart that tune the time-averaged strength of the electric field of laser shot as negative and corresponding schematics.

Practically, the step determining negative polarity of the time-averaged electric field with respect to the normal to the graphene sheet is decomposed by following steps: (S301) The first positive threshold is in positive direction, and the second threshold that has five times intensity of the first threshold is in negative direction, (S302) changing the zero field into the strength and polarity of the first threshold, mentioned above, in the time range from 0 fs to 1 fs, that is a quarter of the full width of half maximum of the pulse, (S303) changing the intensity and polarity of the first threshold mentioned above to those of the second threshold mentioned above in the time range from 1 fs to 2 fs, that is a quarter of the full width of half maximum of the pulse, (S304) changing the intensity and polarity of the second threshold to those of the first threshold in the time range from 2 fs to 3 fs, that is a quarter of the full width of half maximum of the pulse, and (S305) changing the intensity and polarity of the first threshold to zero field in the time range from 3 fs to 4 fs, that is a quarter of the full width of half maximum of the pulse.

In FIG. 3(b), the treatment of pulse shape that tunes the time-averaged field intensity in positive direction was shown in the displayed flow-chart.

Practically, the step determining positive polarity of the time-averaged electric field with respect to the normal to the graphene sheet is decomposed by following steps: (S311) The first threshold is in negative direction, and the second threshold that has five times intensity of the first threshold is in positive direction, (S312) changing the zero field into the strength and polarity of the first threshold, mentioned above, in the time range from 0 fs to 1 fs, that is a quarter of the full width of half maximum of the pulse, (S313) changing the intensity and polarity of the first threshold mentioned above to those of the second threshold mentioned above in the time range from 1 fs to 2 fs, that is a quarter of the full width of half maximum of the pulse, (S314) changing the intensity and polarity of the second threshold to those of the first threshold in the time range from 2 fs to 3 fs, that is a quarter of the full width of half maximum of the pulse, and (S315) changing the intensity and polarity of the first threshold to zero field in the time range from 3 fs to 4 fs, that is a quarter of the full width of half maximum of the pulse.

By performing the time-dependent first principles simulation (patented reference 3, non-patented reference 7), these pulse can give concentrated and considerable high kinetic energy to an oxygen atom. (See, FIG. 4 (b))

The direction of the motion is toward leaving direction from graphene.

The quantity of the kinetic energy was found to be dependent on pulse shapes displayed in FIG. 4(a) (from (i) to (iv)).

As displayed in FIG. 1, pulse shape displayed in FIG. 4 (a) (iv) gave the largest kinetic energy 0.035 eV on an oxygen atoms whose bonding direction is above the graphene sheet (followed by the direction of FIG. 1) under laser illumination from above to below the graphene sheet.

Namely, in the pulse, the intensity and polarity of the pulse is changing depending on time.

In case of taking time-average of the intensity and polarity are taken, the negative electric field gives force on electron cloud in FIG. 1 upward from the graphene sheet, while positive electric field gives force on electron cloud in downward from the graphene sheet.

Therefore, in order to efficiently reduce oxygen atoms absorbing upper region of graphene sheet, the negative time-averaged field is suitable, while in order to reduced oxygen atoms absorbing lower region of the graphene sheet, the positive time-averaged field gives the maximum efficiency.

By increasing the maximum intensity of the laser field to 12 V/Å with pulse shape (iv) of FIG. 4(a), the given kinetic energy to an oxygen atom is increased as 0.08 eV.

Although the energy density of the laser is proportional to the square of the intensity of the electric field of the laser, current time-dependent first-principles simulation gives higher rate of energy transfer to an oxygen atom beyond the ratio proportional to the square of the field intensity.

This suggests that the stronger intensity of laser shots tends to give higher kinetic energy only on oxygen atoms, thus high intensity of laser contributes to extracting oxygen atoms from graphene oxide.

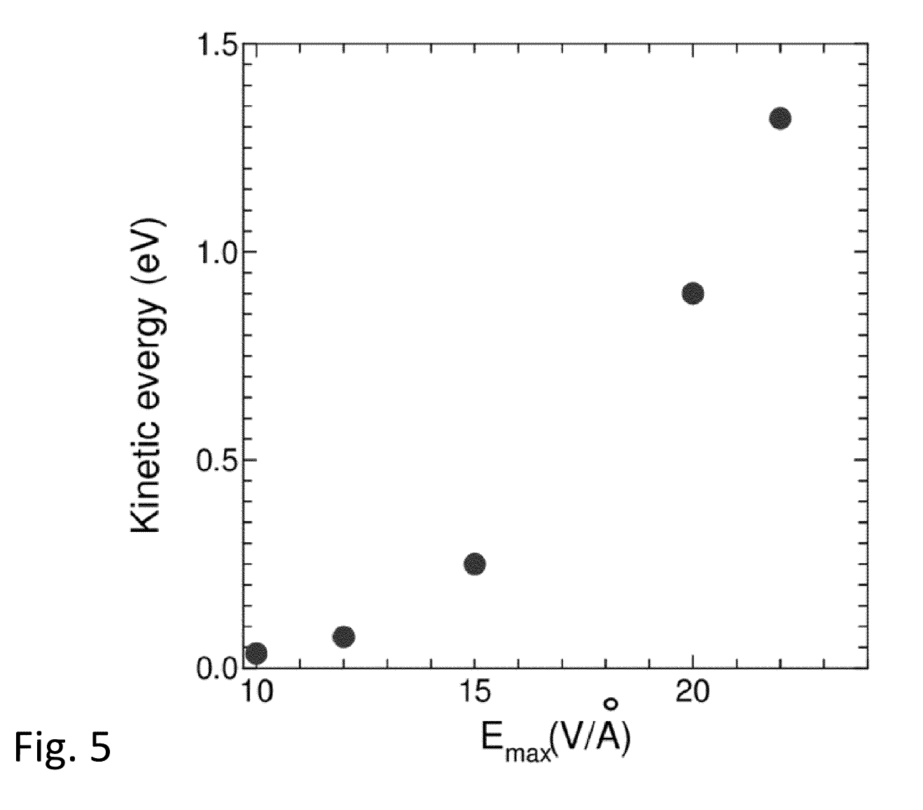

Further simulations were done with the maximum intensity of the laser field as 15V/Å, 20V/Å, 22V/Å and the relation of the maximum intensity and given kinetic energy to an oxygen atom is displayed in FIG. 5.

Indeed, the necessary kinetic energy threshold for an oxygen atom to be desorbed from graphene sheet is estimated from 0.8 eV to 1.0 eV.

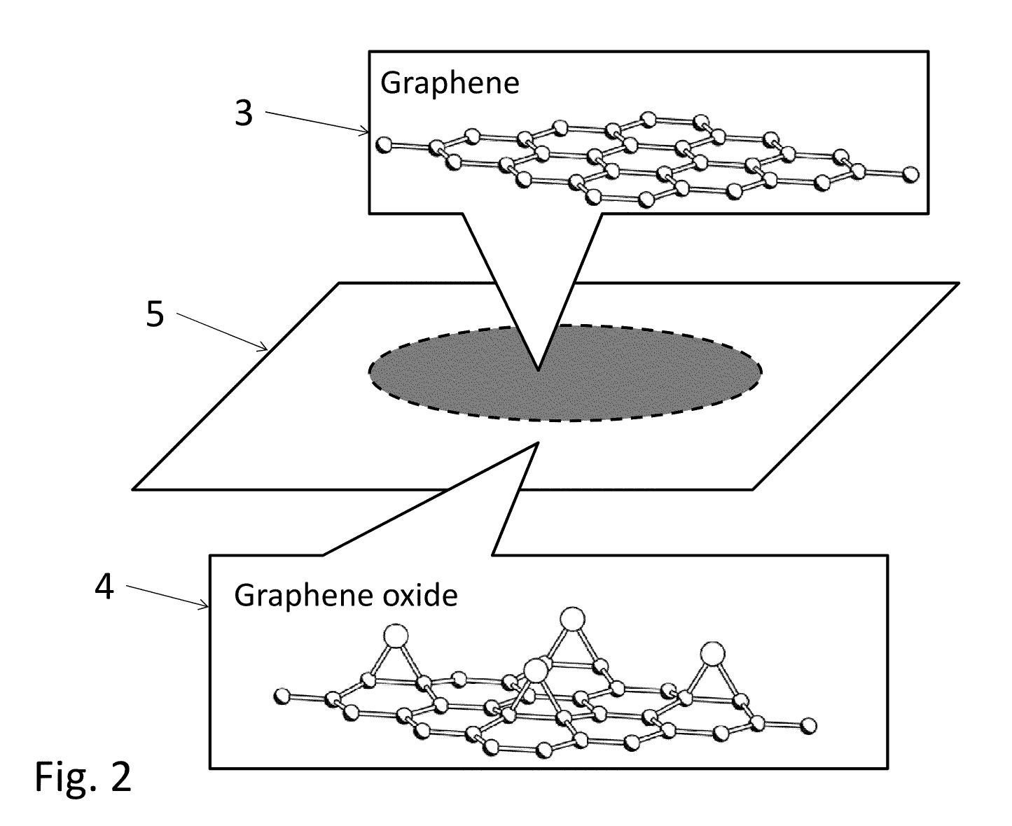

This is derived from empirical rule (non-patented reference 8, and FIG. 2 of this) that needed energy threshold for desorption under electronic excitation is approximately one fifth of that under the electronic ground state.

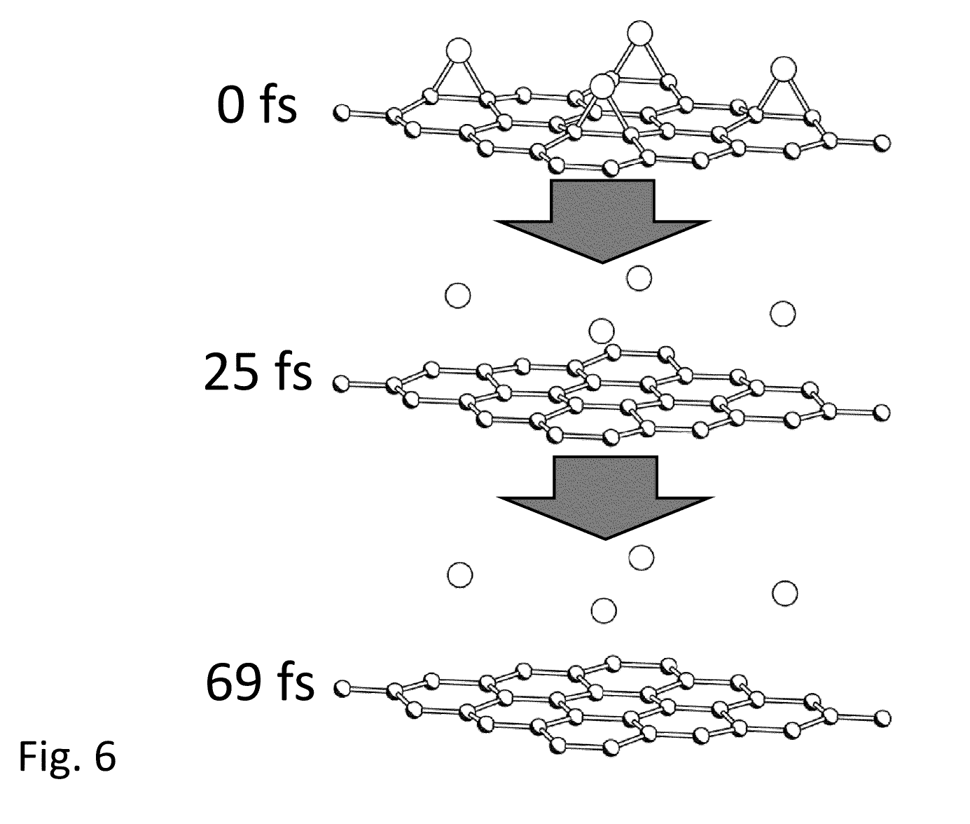

According to the time-dependent first-principles calculation, the simulation result shown in FIG. 5 shows necessary maximum intensity of the electric field of the laser is between 20 V/Å to 22 V/Å. (The detailed feature of oxygen desorption will be displayed later in FIG. 6)

Meanwhile, the maximum intensity beyond 22V/Å is not recommended due to possible breakage of pristine graphene.

Since the energy density of the femtosecond laser is given by ½ ∈₀c E² (here ∈₀ is vacuum dielectric constant and c is velocity of light), the electric field of 10 V/Å needs 1.327×10¹⁵ W/cm², and for the value of 20 V/Å, the needed quantity is four times bigger than this values.

Such a large energy density can be realized by experimental laser power like as 4×10¹⁵ W/cm² was reported (non-patented reference 9).

According to the time-dependent first-principles simulation, as displayed in FIG. 6, the pulse with the maximum intensity of 20 V/Å gives complete desorption of the oxygen atoms which leaves 3 Å away from the graphene sheet within 70 fs.

From above results, reduction of graphene oxide by short pulse femtosecond laser is available.

By using this reduction method, shining a tuned femtosecond laser on graphene oxide made of graphite oxide, it is clarified that the spatially separated graphene oxide region and pristine graphene region can be fabricated on a single graphene sheet.

In this procedure, the kinetic energy on the oxygen atom remain as 0.1 eV and the averaged kinetic energy for carbon atoms of graphene is smaller by magnitude of that of the oxygen atom.

Thus this invention has a property that reduction using the femtosecond laser never causes heating on the graphene oxide.

Here it must be mentioned that the first-principles simulation which is a base of this invention is a numerically accurate computation on the foundation of the quantum mechanics and thus useful to predict phenomena in nature.

The extracted oxygen atoms shown in FIG. 6 are radical, so there is a possibility of chemical reaction again with graphene.

To reduce this probability significantly, this reduction process is favored to be done under environment with either nitrogen or hydrogen gases.

With this environment, the extracted oxygen atoms react with gases and forming water molecules or oxy-nitride molecules which significantly reduce the probability of reacting with graphene.

### Example 3

By choosing shining region of the femtosecond laser on selected area of the graphene oxide, one can pattern the electrically conducting region on the graphene oxide.

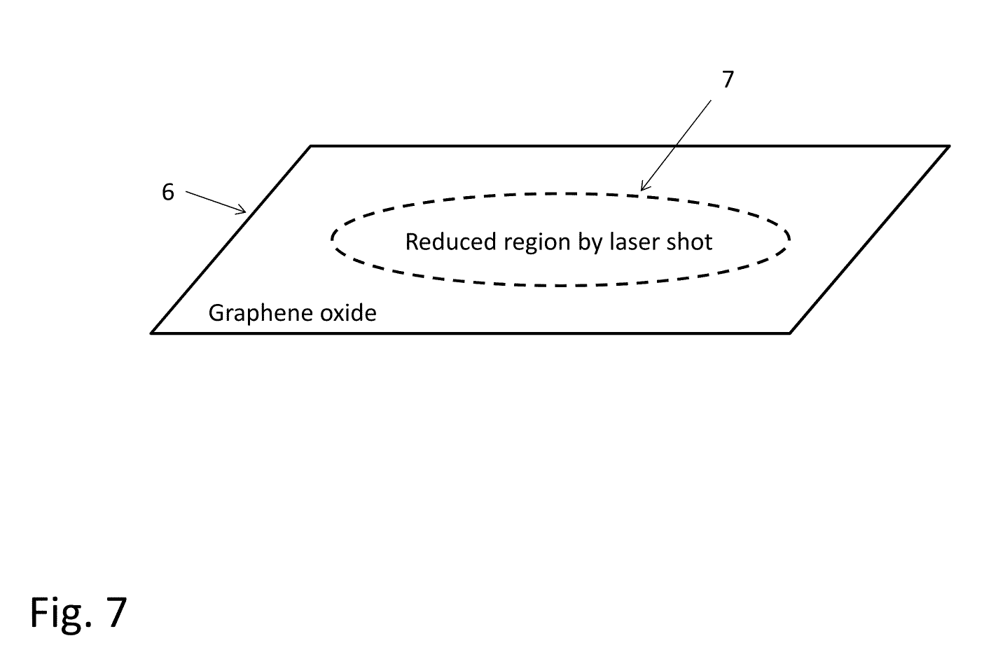

As an example of selected pattern of conducting region by reduction, FIG. 7 shows oval region of electrical conducting region at the center of a graphene oxide sheet.

### INDUSTRIAL APPLICATIONS

Furthermore, after coating the graphene oxide on the surface of solar cell, laser shot that reduces the graphene oxide can form transparent electrodes.

By tuning the remaining oxygen density of the electrode with modifying the laser illuminating time and intensity, the transparency and conductance of electrode, which are in trade-off relation, can be globally optimized.

The femtosecond laser used in practical example 1 can also be applied for forming new structure of graphene starting from other kind of graphene nano-materials.

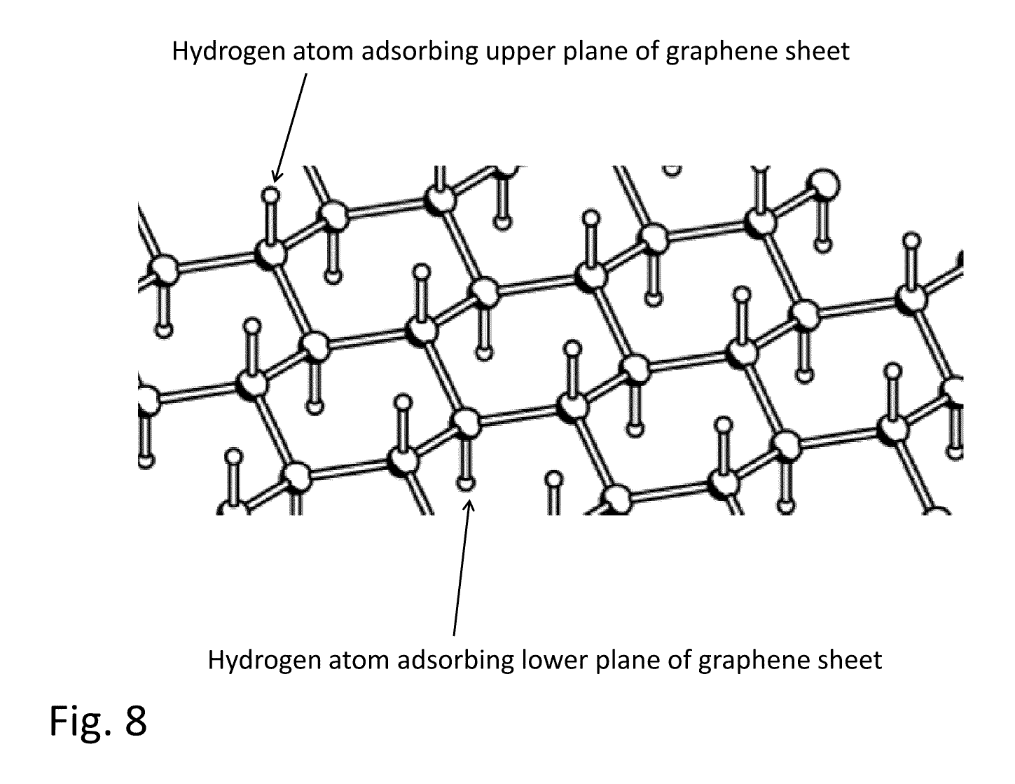

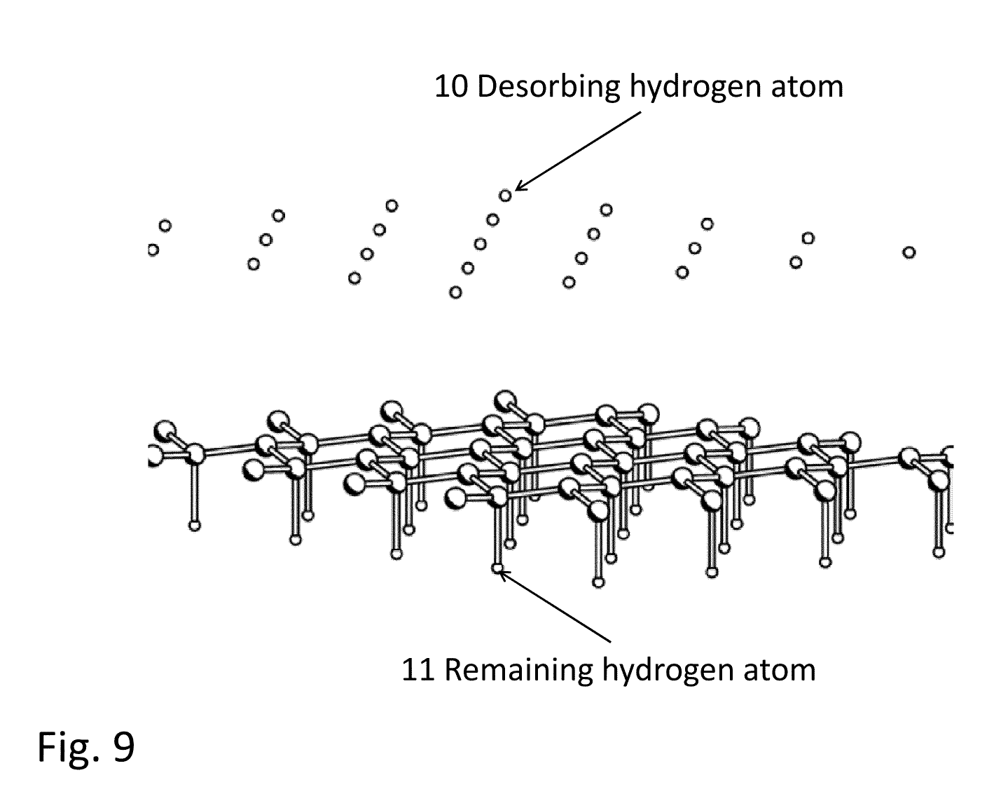

In practical example 4, we express the invention using FIG. 9. The invention is removal of hydrogen atoms from one-side of hydrogenated graphene of FIG. 8 by using the pulse same as practical example 1 used for reduction of graphene oxide. The laser illumination should be done on either of the two planes of the hydrogenated graphene and thus the new invention obtains the structure of graphene whose one side is hydrogen terminated and the other side has no termination.

Indeed, the femtosecond laser shined from the top of FIG. 8, with the tuned pulse shape accordingly with the procedure shown in FIG. 3 and with the time-averaged field polarity negative can induce dehydrogenation only from top side, as shown in FIG. 9, according to the first-principles simulation.

In order to complete the one-side dehydrogenation shown in FIG. 9, the maximum intensity of the laser field shown in FIG. 3 must be set as 20 v/Å.

Meanwhile, when the polarity of the laser field is inverted, the hydrogen in FIG. 9 is desorbed in lower plane while hydrogen remains in upper plane.

For confirming the temperature effect, we also examined the possible raise of temperature near the region of laser illumination as follows.

The kinetic energy of remaining hydrogen atoms shown in FIG. 9 is 0.113 eV according to the numerical data of the first-principles simulations.

By considering the temperature and energy relation such as 1 eV=11600K, the kinetic energy of 0.113 eV corresponds to 600 degree C. using the Maxwell-Boltzmann distribution function that gives averaged kinetic energy=3/2×absolute temperature, thus 0.113×11600×2/3=873 K=600 degree C.

With this temperature raise, the remaining hydrogen and graphene structure remain as intact.

### Example 5

Furthermore, in practical example 5 shows a method to obtain a new graphene structure from the structure of practical example 4.

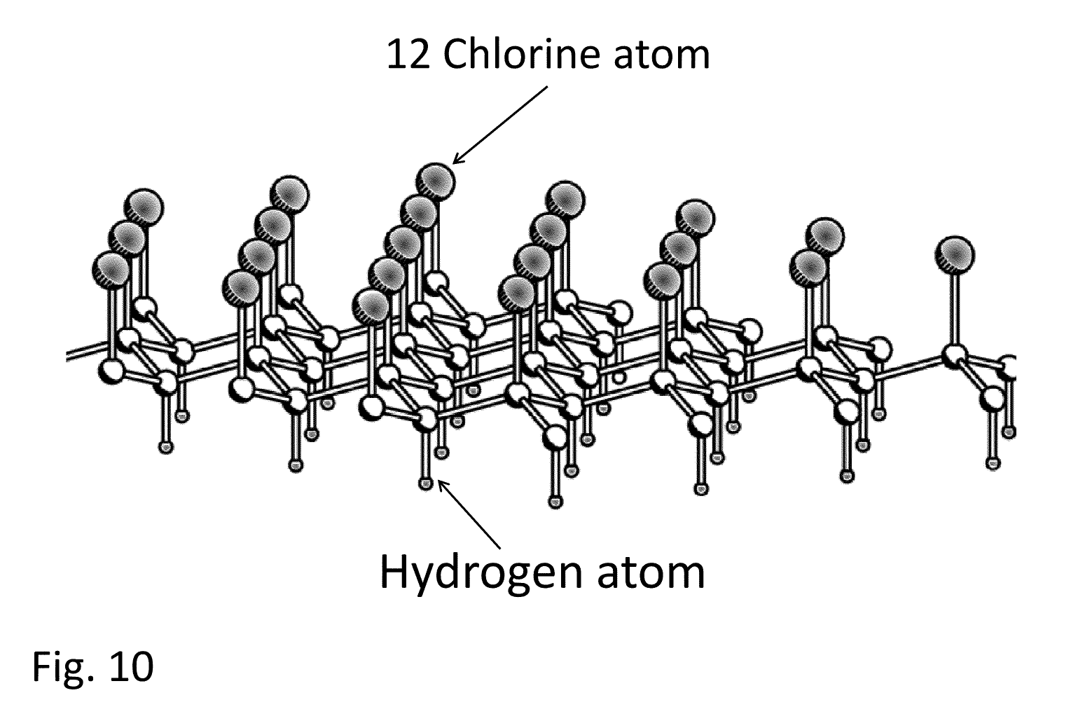

As displayed in FIG. 10, the upper plane lacking hydrogen termination can be terminated by halogen atoms which are monovalent as hydrogen atoms.

FIG. 10 shows chlorine adsorption.

For chlorine adsorption, introduction of chlorine molecules is considered.

At the situation of FIG. 9 with sample temperature of 600 degree C., the dissociation of molecular chlorine gives chlorine adsorption exothermically thus this reaction normally proceeds.

Yet the energy gain is small as 0.78 eV per one chlorine atoms. (Normal value of chemisorption should be few eV.)

This low value is due to larger effective radius of chlorine atoms which causes lattice strain by around 10% causing energy cancelling between strain loss and energy gain by chemisorption.

However, thanks to thermal energy, the chemisorption is possible to obtain the structure of FIG. 10.

Some of chlorine atoms are likely to go lower plane and to react with hydrogen atoms to alternate to them, or adsorb on hydrogen-free sites.

However, in thermo-dynamical limit, due to more the reactive nature of hydrogen-free site and to steric effect the adsorption rate on hydrogen terminated site is estimated as less than 10%.

Accordingly, the obtained structure shown in FIG. 10 has polar nature which is applicable in electronic devices.

In order to perform first-principles simulation, we set the periodic boundary condition including two sheets of the hydrogen- and chlorine-terminated graphene setting the same polarity as face-to-face.

The potential in between the sheets has a characteristic of giving 2.1 V higher value in chlorine terminated side than hydrogen terminated side.

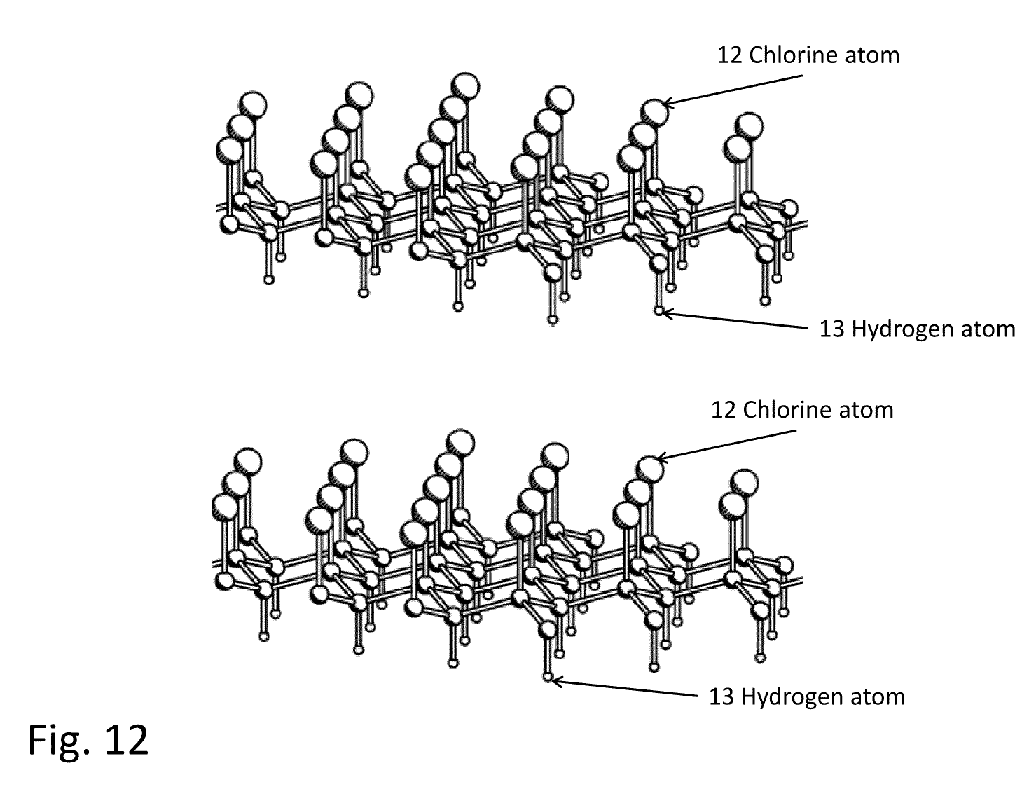

On the other hand, as shown in FIG. 12, two sheets who have structures as shown in FIG. 10 orient chlorine terminated plane and hydrogen terminated plane as face-to-face, the electric field of 0.0762V/Å was found to be generated.

In the structure of FIG. 10, substitution of chlorine atoms to fluorine atoms also makes stable structure.

In this case, absorption energy gain by dissociating fluorine molecule is high as 4.1 eV per atom.

Compared to dissociation of chlorine molecule, dissociation of fluorine molecules needs higher energy. Yet absorption of fluorine requires less lattice deformation resulting only 3% of expansion of graphene lattice.

In the structure of FIG. 10, if chlorine atoms are alternated by fluorine atoms, the bias difference of fluorine terminated plane is 5.2 V higher than hydrogen terminated plane according to the first-principles calculation.

This implies fluorine termination gives larger amount of the charge transfer between upper and lower sides of graphene sheet, compared to the case of chlorine termination.

Furthermore, two sheets of fluorine and hydrogen terminated graphene cause electric field of 0.29 V/Å when fluorine and hydrogen terminated planes are face-to-face.

This is field bigger compared to the chlorine terminated case.

Thus one-side hydrogen termination with halogen (chlorine or fluorine) termination on the other side can inside bias difference in between the two sides.

From this fact, it is concluded that approaching a sheet which has a structure of FIG. 10 to another sheet with the same structure can cause Coulomb interaction.

Unfortunately, the first-principles calculation needs periodic boundary condition that makes array of these two sheets.

Because of the fact that we treat infinite number of the sheets as parallel sheets, and the fact that the electric field generated by these sheets are constant with respect to inter-sheet distance, we cannot directly compute the Coulomb attracting forces due to a cancellation of Coulomb forces in periodic arrays.

Yet, we can estimate the inter-sheet interaction by using the value of electric field obtained.

The chlorine terminated case and fluorine terminated case respectively generated the field of 0.076V/Å and 0.29V/Å.

But these values are influenced by both charges on hydrogen terminated side and halogen terminated side.

Therefore, the strength of electric field without periodic boundary condition is estimated as half value of the computed value with the periodic boundary condition.

In each case, we assume the case that inter-sheet distance is reduced from 15 Å to 4 Å (by 11 Å).

Assuming the constant strength of electric field upon reduction of the inter-sheet distance, the attractive potential is estimated by 0.5×0.076×11=1.6 eV for chlorine and hydrogen terminated case, while 0.5×0.29×11=1.6 eV for fluorine and hydrogen terminated case.

This value is larger value by two magnitude of typical van der Waals interaction.

Meantime, when the planes with the same polarity are face-to-face, no attractive force is generated.

For other case, when we coat graphene oxide on the surface of solar cell and give conductivity by laser induced reduction, we can fabricate transparent electron on the solar cell.

Changing remaining oxygen density by tuning laser duration time and intensity, we can optimize both transparency and conductivity which are in trade-off relation.

### REFERENCE NUMBERS

1 carbon atoms
2 oxygen atom
3 graphene
4 graphene oxide
5 structure of graphene oxide
6 sheet of graphene oxide
7 reduced region by laser shot.

What is claimed is:

1. A sheet material, comprising structures of graphene oxide and graphene, wherein the graphene oxide and the graphene are chemically connected to form a plane, and the sheet material has a region of the graphene oxide and a region of the graphene which are divided on the plane.

2. A method of reduction of graphene oxide, comprising the steps of:
providing a sheet material comprising at least one atomic layer of graphene oxide and a femtosecond laser apparatus that can emit a femtosecond laser shot;
tuning a pulse shape and an intensity of an electric field formed by the laser shot; and
emitting the laser shot onto a region of the graphene oxide sheet in a controlled manner to reduce the graphene oxide on the region.

3. The method of reduction of graphene oxide according to claim 2, wherein the tuning step comprises:
tuning the pulse of the laser shot to have 2 fs of the full width at the half-maximum of the pulse, a wavelength of the laser to be 800 nm, and an average intensity of the electric field for 4 fs of the full width time range to be negative with respect to a normal axis of the graphene layer; or
tuning the pulse of the laser shot to have 2 fs of the full width at the half-maximum of the pulse, a wavelength of the laser to be 800 nm, and an average intensity of the electric field for 4 fs of the full width time range to be positive with respect to a normal axis of the graphene layer.

4. The method of reduction of graphene oxide according to claim 3,
wherein the step of tuning the average intensity to be negative comprises the following sub steps:
setting a first threshold that is positive and a second threshold that is negative and has a five time intensity of the first threshold;
increasing the intensity of the field from zero to the first threshold in the time range from 0 fs to 1 fs, that is a first quarter of the full width at the half maximum of the pulse;
decreasing the intensity of the field from the first threshold to the second threshold in the time range from 1 fs to 2 fs, that is a second quarter of the full width at the half maximum of the pulse,
increasing the intensity of the field from the second threshold to the first threshold in the time range from 2 fs to 3 fs, that is a third quarter of the full width at the half maximum of the pulse; and
decreasing the intensity of the field from the first threshold to zero in the time range from 3 fs to 4 fs, that is a fourth quarter of the full width at the half maximum of the pulse, and
wherein the step of tuning the average intensity to be positive comprises the following sub steps:
setting a third threshold that is negative and a fourth threshold that is positive has a five time absolute value of the third threshold;
decreasing the intensity of the field from zero to the third threshold in the time range from 0 fs to 1 fs, that is a first quarter of the full width at the half maximum of the pulse;
increasing the intensity of the field from the third threshold to the fourth threshold in the time range from 1 fs to 2 fs, that is a second quarter of the full width at the half maximum of the pulse,
decreasing the intensity of the field from the fourth threshold to the third threshold in the time range from 2 fs to 3 fs, that is a third quarter of the full width at the half maximum of the pulse; and
increasing the intensity of the field from the third threshold to zero in the time range from 3 fs to 4 fs, that is a fourth quarter of the full width at the half maximum of the pulse.

5. The method of reduction of graphene oxide according to claim 2, wherein the method further comprises the step of tuning a maximum intensity of the electric field in the pulse shape to be from 10 to 20 V/Å.

6. The method of reduction of graphene oxide according to claim 2, wherein the irradiation with the laser is performed when the sheet material of graphene oxide is kept in a nitrogen gas or hydrogen gas environment.

7. A method of forming a pattern formed of graphene oxide and graphene, the method comprising:
selecting a region of a graphene oxide sheet in a controlled manner and irradiating the region with the femtosecond laser by the method of according to claim 2; and
forming the pattern in which the graphene oxide and the graphene coexist on the same plane.

8. A method of removing hydrogen atoms from a graphene sheet structure, comprising:
irradiating one of two sides of the graphene sheet structure which are hydrogen-terminated, with a femtosecond laser, while tuning the pulse shape and the intensity of the electric field by the method according to claim 3, thereby selectively removing hydrogen atoms from one of the two sides of the graphene sheet structure.

9. A method of producing a graphene sheet structure, comprising:
providing a graphene sheet structure from which hydrogen atoms were removed from one of the two sides of the graphene sheet structure by the method according to claim 8; and
attaching selectively halogen atoms to the one side of the graphene which are no longer hydrogen-terminated, thereby producing the graphene sheet structure having the hydrogen-terminated side and the halogen-terminated side.

10. The method of producing the graphene sheet structure according to claim 9, wherein the halogen atoms are chlorine atoms or fluorine atoms.
